(19) United States
(12) Patent Application Publication
(10) Pub. No.: US 2026/0064631 A1
(43) Pub. Date: Mar. 5, 2026

(54) TECHNIQUES FOR PROPAGATING RETENTION POLICY CHANGES FOR RECOVERY FROM AN ARCHIVE

(71) Applicant: Rubrik, Inc., Palo Alto, CA (US)

(72) Inventors: Harshadrai Gajendrakumar PAREKH, San Jose, CA (US); Aditya KHANDKAR, Mountain View, CA (US)

(21) Appl. No.: 18/824,890

(22) Filed: Sep. 4, 2024

(51) Int. Cl. G06F 16/11; G06F 11/14

(52) U.S. Cl. CPC G06F 16/125; G06F 11/1469; G06F 16/113; G06F 2201/84

(57) ABSTRACT

Methods, systems, and devices for data management are described. A data management system may establish a first data system that stores and retains data objects in accordance with a service level agreement (SLA) retention policy. The data management system may also store one or more backups of the data objects in an archival location. In some aspects, the data management system may obtain an indication of one or more updates made to the SLA retention policy and may perform an on-demand job to propagate the updates made to the SLA retention policy to the backups stored in the archival location. The data management system may then establish a secondary data system having read-only permissions, and may promote the secondary data system from the read-only permissions to owner permissions in order to access, manage, and recover the archived data objects with a most up-to-date SLA retention policy.

### FIELD OF TECHNOLOGY

The present disclosure relates generally to data management, including techniques for propagating retention policy changes for recovery from an archive.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports techniques for propagating retention policy changes for recovery from an archive in accordance with aspects of the present disclosure.

FIGS. 2 and 3 show examples of a data management and backup systems that support techniques for propagating retention policy changes for recovery from an archive in accordance with aspects of the present disclosure.

FIG. 4 shows an example of a process flow that supports techniques for propagating retention policy changes for recovery from an archive in accordance with aspects of the present disclosure.

FIG. 5 shows a block diagram of an apparatus that supports techniques for propagating retention policy changes for recovery from an archive in accordance with aspects of the present disclosure.

FIG. 6 shows a block diagram of an archival retention manager that supports techniques for propagating retention policy changes for recovery from an archive in accordance with aspects of the present disclosure.

FIG. 7 shows a diagram of a system including a device that supports techniques for propagating retention policy changes for recovery from an archive in accordance with aspects of the present disclosure.

FIGS. 8 through 10 show flowcharts illustrating methods that support techniques for propagating retention policy changes for recovery from an archive in accordance with aspects of the present disclosure.

### DETAILED DESCRIPTION

A user may store data objects in one or more primary data storage locations (e.g., in one or more primary data systems or one or more primary data clusters), and may store backups of the data in various different archival locations, including external archives such as Google cloud, Microsoft Azure, or other cloud-based storage locations, or in on-premises storage. The storage of data backups in an external archive may allow for added reliability and security for recovering data in case of primary hardware failures, accidental deletion, cyberattacks and other potential problems occurring at the primary data storage location. For example, to access data backups in the archival storage, a user may set up a secondary data cluster in the archival location with read-only permissions, and may promote the secondary data cluster to have owner permissions to access backups in cases that the primary cluster is lost, needs to be decommissioned, or is otherwise corrupted in some way. When the secondary cluster is promoted to be the new owner for the archival storage, it is able to manage the retention of the backups present in the archive.

In some cases, however, the process of establishing a secondary cluster may cause challenges for effectively implementing a most up-to-date retention policy for retaining backups in the archival storage. For example, when writing a backup to the archive, the primary cluster may use a service level agreement (SLA) retention policy of the backup as defined at the creation time of the backup, rather than the most recent SLA retention policy. In addition, in some cases, the SLA retention of the backup may be updated by the user on the data management system, but such updates may not be reflected in the archival storage, so when the secondary cluster connects to the archive to recover the metadata of the stored data backups, the secondary cluster may do so based on outdated SLA retention information.

A data management system may implement various techniques to support ongoing tracking and maintenance of accurate SLA retention information for backups stored in an archive. Broadly, a user may assign a retention policy to a backup at the time the backup is taken, and the user may change the policy at a later time if desired. For example, when writing a backup to the archive, the user may track the current retention information of the backup in addition to the creation time retention information. Then, when the retention is updated for a backup in the archive, the retention information (and a history of the retention information) may be updated in the archive in an on-demand fashion. In some cases, if a user performs a retention change operation which may impact an individual backup, a snappable, or a group of snappables or backups, the retention information may be updated in the local metadata store in order to enable the most up-to-date retention information for the backups. For example, updating the retention policies may include queuing different updates to the retention policies, propagating features to update the archival retention of every snapshot in the archive, reading and storing the SLA information as part of a reader recovery or refresh job, a one-time job that updates the metadata of the snapshot whose retention has been changed, among other possible updates.

Aspects of the disclosure may be implemented to realize one or more potential advantages. For example, the on-demand updating of retention information for backups in an archival storage location may allow for more accurate recovery of backups if data in the primary storage location is lost or corrupted. In such examples, if the data in the primary storage location is compromised in some way, a user may be able to access a most-recent version of the data with a most-recent SLA retention policy from the archival location. Additionally or alternatively, the techniques described herein may eliminate the ambiguity of determining whether an accessed backup has a most-recent SLA policy. For example, every backup may be stored with a most up-to-date SLA retention policy, allowing the user to accurately determine and confirm the retention policy associated with the backup. Additionally or alternatively, the techniques described herein may allow for more accurate propagation of multiple backups using a queuing mechanism which tracks a history of backups associated with the data and implements updates according to a chronologically accurate timeline.

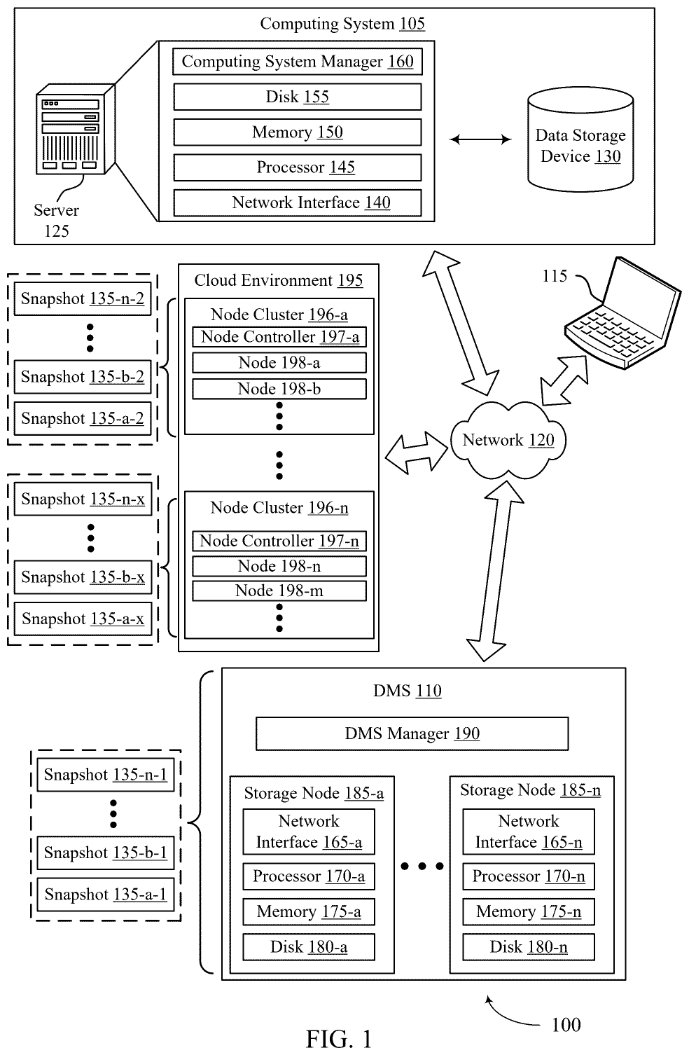

FIG. 1 illustrates an example of a computing environment 100 that supports techniques for propagating retention policy changes for recovery from an archive in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally or alternatively, the DMS 110 may detect whether aspects of the computing system 105 have been impacted by malware (e.g., ransomware). Additionally or alternatively, the DMS 110 may relocate data or create copies of data based on using one or more snapshots 135 to restore the associated computing object within its original location or at a new location (e.g., a new location within a different computing system 105). Additionally or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

The DMS 110 may implement various techniques to support ongoing tracking and maintenance of accurate SLA retention information for backups (e.g., snapshots 135) stored in an archive, such as in the cloud environment 195 or in other archival data storage locations. For example, the DMS 110 may track the current retention information of a data backup (e.g., current SLA retention information) in addition to the SLA retention information at the creation time of the backup. In addition, the DMS 110 may track a history of SLA updates associated with the data backup. When the retention information is updated for a backup in the archive, the retention information (and a history of the retention information) may be updated in the archive in an on-demand fashion. In some cases, if a user performs a retention change which impacts a backup of a data object stored in the archival location, the retention information may be updated in the local metadata store in order to enable to most up-to-date retention information for the backup. For example, updating the retention policies may include queuing different updates to the retention policies, propagating features to update the archival retention of every snapshot in the archive, reading and storing the SLA information as part of a reader recovery or refresh job, a one-time job that updates the metadata of the snapshot whose retention has been changed, among other possible updates.

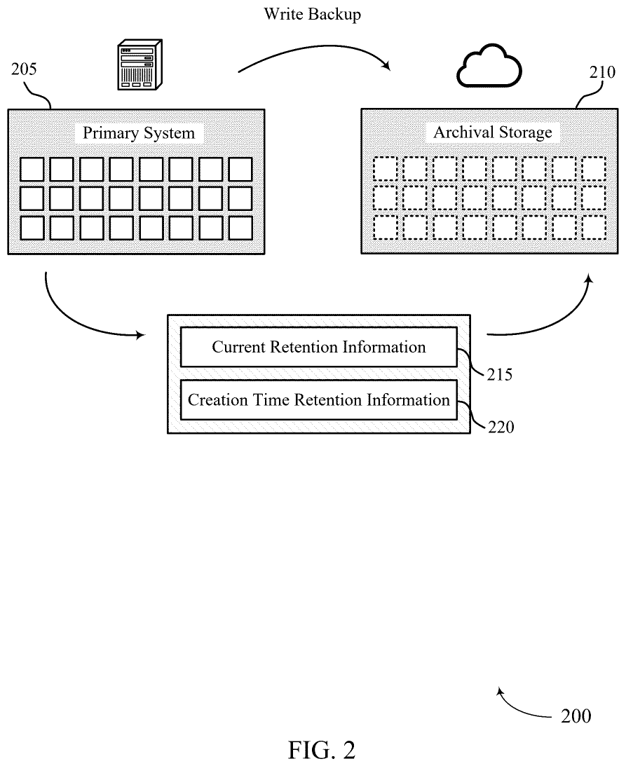

FIG. 2 shows an example of a data management and backup system 200 that supports techniques for propagating retention policy changes for recovery from an archive in accordance with aspects of the present disclosure. For example, the data management and backup system 200 may include a primary data system 205, which may be an example of an archival location 210, which may be an example of an archival data cluster, an archive, a cloud data storage location, or an off-site data storage location.

A primary data system 205 may host protected data, with different backups of the protected data being stored in various different archival locations (e.g., external archives such as Google cloud or Microsoft Azure, Object Store, or on-premises storage) such as the archival location 210. The archival location 210 may allow for added reliability for recovering data from the external archive in case of primary hardware failures, accidental deletion, cyberattacks and other potential problems occurring at a primary data system 205 in which the primary data system 205 becomes unavailable. In order to access the archival location 210, a user may set up a secondary data system in the archival location (or in a data center of the user) to access the data in the archival location 210 with read-only permissions, and may promote the secondary data system to have owner permissions to access backups in cases that the primary data system 205 is lost, needs to be decommissioned, or is otherwise corrupted in some way. When the secondary data system is promoted to be the new owner for the archival location 210, the user may be able to more effectively manage the retention of the backups present in the archival location 210.

In some cases, however, this process of establishing a secondary cluster to access the archived data may cause challenges for effectively implementing and managing the most up-to-date retention policy for the data. For example, when writing a backup to the archive, the primary cluster uses an SLA retention policy of the backup as it was defined at the creation time of the backup, rather than the most recent SLA retention policy (which may have changed since the creation of the backup). Additionally or alternatively, after the backup is written to the archival location 210, the user may change the retention of the backup in the primary data system 205, and this change may not get updated in the archival location 210. Additionally or alternatively, the SLA retention of the backup may remain unchanged once the backup is stored, so when the secondary data system connects to the archival location 210 to recover the metadata of the stored backups, the secondary data system may do so based on outdated SLA retention information.

A data management system may implement various different techniques in order to support tracking and maintaining the most up-to-date retention information for backups stored in the archival location 210. For example, when writing a backup to the archival location 210, the data management system may track the current retention information 215 of the backup (e.g., the most up-to-date retention information for the backup based on the current SLA retention policy) in addition to the creation time retention information 220 of the backup (e.g., the initial retention information for the backup based on the SLA retention policy when the backup was first created). The data management system may also include one or more mechanisms to update the retention policy information and a history of the retention policy information in the archival location 210 (e.g., whenever the retention policy is changed, the retention policy is updated and managed in the archival location 210). In some aspects, a retention policy is assigned to a backup at a time that the backup is taken, and the user may have the ability to change the retention policy of the backup at a later time if desired.

In some implementations, updating the retention policy may include propagating updates to backups in the archive, queuing updates to the retention policy when multiple updates are made, reading and storing the retention policy (and updates to the retention policy) as part of a reader recovery or refresh job, a one-time job that updates the metadata of the snapshot whose retention has been changed, among other possible updates.

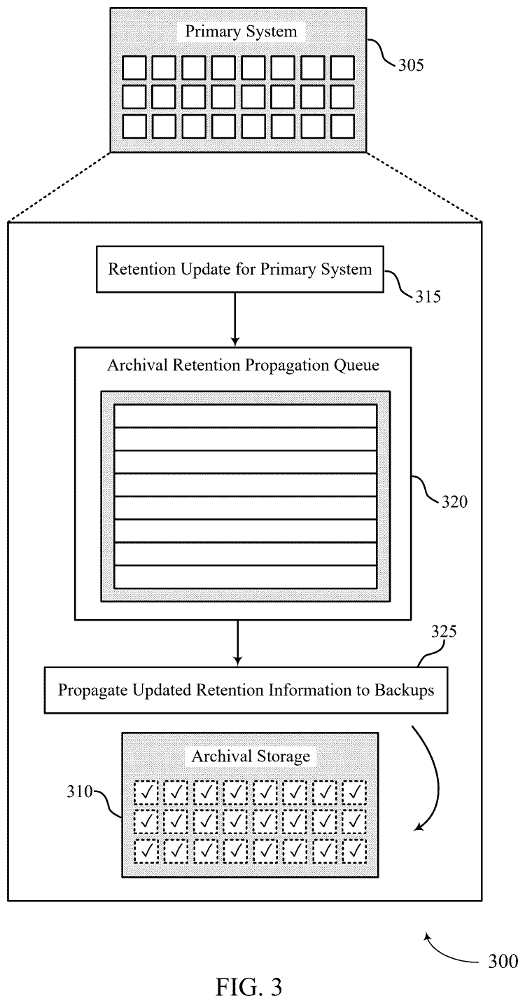

FIG. 3 shows an example of a data management and backup system 300 that supports techniques for propagating retention policy changes for recovery from an archive in accordance with aspects of the present disclosure. For example, the data management and backup system 300 may include a primary data system 305, which may be an example of the primary data system 205 described with reference to FIG. 2, a primary data cluster, a primary data set, or another type of primary system, and an archival location 310, which may be an example of the archival location 210 described with reference to FIG. 2, an archival data cluster, an archive, a cloud data storage location, or an off-site data storage location.

A data management system may support various procedures to track updates made to a retention policy for backups stored in the archival location 310, and to maintain the most up-to-date retention information for backups stored in the archival location 310. In some examples, a data management system may identify one or more updates 315 made to a retention policy for backups of data stored in the primary data system 305. The data management system may track and maintain the one or more updates 315 using an archival retention propagation queue 320, and may asynchronously queue and propagate the one or more updates 315 made to the retention policy for the backups. In some aspects, the archival retention propagation queue 320 may be maintained for all pending retention changes that are pending propagation to the archival location 310.

In some implementations, a user may make one or more changes or updates to the retention policy for the one or more backups stored in the archival location 310, and a corresponding entry is added to the archival retention propagation queue 320 for each of the one or more changes or updates. In some examples, the presence of entries in the archival retention propagation queue 320 may trigger an asynchronous on-demand job which may process the entries in the archival retention propagation queue 320, and may propagate the one or more changes or updates made to the retention policy to the archival location 310 such that the backups stored in the archival location 310 are associated with the most up-to-date retention policy.

In some aspects, the archival retention propagation queue 320 may allow for granularly updating a retention policy, for example, when updates are made to a specific backup, for a specific workload or data object (e.g., a specific virtual machine, a specific file set, a specific server such as a SQL server), or for an SLA policy which would impact all objects and backups protected by an associated SLA domain. In such examples, updates made for a certain granularity may be added to the archival retention propagation queue 320 as separate entries, and a propagation job may propagate updates for each entry in the archival retention propagation queue 320. For example, if an update is made to a specific data object, an entry may be made in the archival retention propagation queue 320 and propagated to the specific data object. Additionally or alternatively, if an entire backup (including multiple data entries) is updated, an entry may be made in the archival retention propagation queue 320 which propagates updates to the entire backup.

In some examples, a user may make multiple retention changes which may affect backups stored in the archival location 310. For example, a backup in the archival location 310 may be subject to multiple retention changes and corresponding updates. To ensure that the changes are not lost, and that the data management system maintains an accurate history of the updates made to the backup, the data management system may support file versioning to track the updates. For example, a new file version may be uploaded with new retention information each time an update is made to the retention policy. In some cases, a recovery workflow system may identify one or more updated file versions, and may select the latest valid file version to recover data from, such that the recovered data has the latest retention policy information.

In some implementations, the archival retention propagation queue 320 may be a propagation queue table that includes pending archival retention propagation requests. In some aspects, when a user performs a retention change operation that impacts an individual backup (e.g., a snapshot), a data object (e.g., a snappable), or a group of data objects or backups, the retention information may be updated in a local metadata store, and an entry may be added to the archival retention propagation queue 320 so that the updates may be propagated to the backups stored in the archival location 310.

In some examples, the data management system may support an on-demand job (e.g., an archival retention propagation job 325) for processing and executing pending entries in the archival retention propagation queue 320. For example, the on-demand job may identify pending requests or entries from the archival retention propagation queue 320, which may be sorted by the respective creation time of the entries (e.g., the entry with the oldest creation time or timestamp may have a highest priority, and the entry with the most recent creation time or timestamp may have the lowest priority). The on-demand job may then, for each pending request or entry, process the request based on the scope of the request or entry. For example, if the scope of the request or entry includes updating an individual backup (e.g., a snapshot) the on-demand job may propagate updated retention information to the individual backup. In such examples, the on-demand job may generate new or updated metadata for the individual backup based on the latest retention information, and may upload a new version of the metadata file (including the new or updated metadata) to the archival location 310. The on-demand job may then mark the request or entry in the archival retention propagation queue 320 as completed.

In some other examples, the scope of the request or entry may include updating retention information for a data object (e.g., a snappable), and the on-demand job may propagate the updated retention information for all affected backups of the data object. In such examples, the on-demand job may identify the affected backups to which the updated retention information applies, and the on-demand job may generate new or updated metadata for each of the affected backups. The on-demand job may then upload a new version of the metadata file (which includes the new or updated metadata for each of the affected backups) to the archival location 310, and may mark the request or entry in the archival retention propagation queue 320 as completed.

In some other examples, the scope of the request or entry may include updating retention information for all of the backups in the archival location 310, so that the on-demand job may propagate the updated retention information for all pre-existing backups which may have outdated retention information in the archival location 310. In such examples, the on-demand job may generate new or updated metadata for all of the backups in the archival location 310 and may upload a new version of the metadata file (which includes the new or updated metadata for each of the backups) to the archival location 310, and may mark the request or entry in the archival retention propagation queue 320 as completed.

In some aspects, the on-demand job may support mechanisms to effectively handle system failures to reduce the likelihood that pending updates are dropped due to system failures or offline times. For example, if the archival location 310 is in a disabled or disconnected mode (or any other mode that prohibits uploading of new metadata files), any pending request in the archival retention propagation queue 320 may be re-queued and preserved in the archival retention propagation queue 320 as pending requests so that a future instance of the on-demand job may handle the pending requests when the archival location 310 becomes accessible at a later time. Additionally or alternatively, a backup may exist in more than one archival location (e.g., in accordance with a multiple archival locations feature) and not all archival locations may be accessible. In such cases, the periodic job may upload updated metadata to one or more accessible archival locations, and keeps the request pending so that a future instance of the on-demand job may handle the request when the archival location associated with the request becomes accessible.

In some aspects, the on-demand job may be implemented such that a new job instance is triggered based on pending entries in the archival retention propagation queue 320 (e.g., each time a new entry is added to the archival retention propagation queue 320, a new job instance of the on-demand job may be triggered). In some examples, when a user makes a change or update to a retention policy, a new entry may be added to the archival retention propagation queue 320, and a new on-demand job instance is created. In some examples, if the change or update to the retention policy involves backups stored in an inaccessible archival location, the on-demand job instance may be created when the archival location becomes accessible. In some examples, an on-demand job instance may be created to process all pre-existing backups whenever a previous software release is updated to a new release version. In some aspects, a periodic background job (different from the on-demand job) may periodically monitor the archival retention propagation queue 320 to ensure that no pending requests exist in the archival retention propagation queue 320 that are unprocessed. In some aspects, the on-demand job may identify whether any additional updates have been made to the retention information of a queued entry between the time that the entry was made and the time that the on-demand job is run.

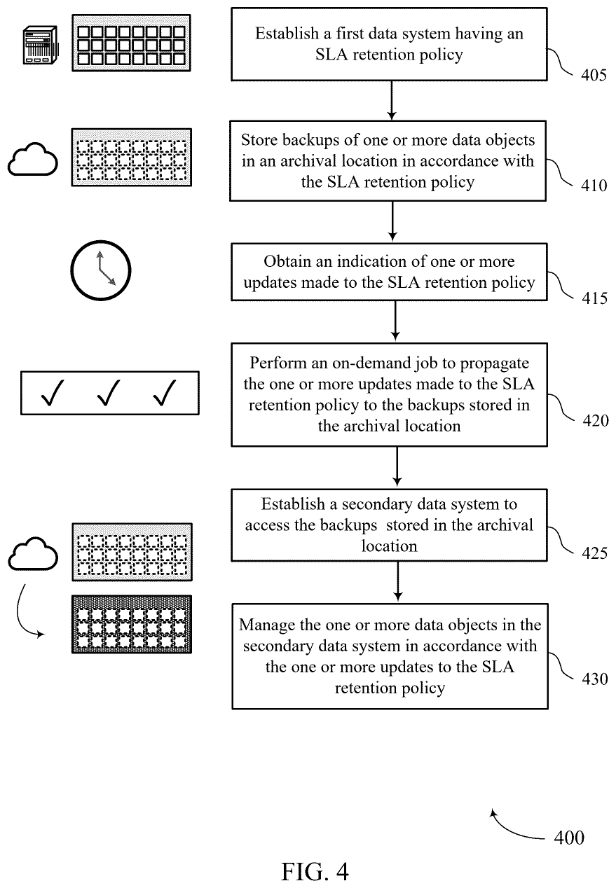

FIG. 4 shows an example of a process flow 400 that supports techniques for propagating retention policy changes for recovery from an archive in accordance with aspects of the present disclosure. For example, the processes of process flow 400 may be implemented at or by a data management system.

In the following description of process flow 400, the operations may be performed in a different order than the order shown, or other operations may be added or removed from the process flow 400. For example, some operations may also be left out of process flow 400, may be performed in different orders or at different times, or other operations may be added to process flow 400. Although aspects of the process flow 400 are shown occurring at a data management system, the operations of process flow 400 may also be performed by one or more other data systems, software implementations, or other technologies.

At 405, the data management system may establish a first data system in accordance with an SLA retention policy. In some aspects, the SLA retention policy may indicate or include a first duration that one or more backups of one or more data objects are to be retained by the first data system.

At 410, the data management system may store the one or more backups of the one or more data objects in an archival location in accordance with the SLA retention policy established for the one or more data objects in the first data system. In some examples, the one or more data objects may correspond to one or more individual backups, one or more data snapshots or snappable, one or more groups of snapshots, one or more groups of backups, or any combination thereof.

At 415, the data management system may obtain, from a user, an indication of one or more updates that are made to the SLA retention policy. In some aspects, the data management system may track retention information associated with the SLA retention policy over a time duration. For example, the retention information may include at least the SLA retention policy corresponding to a creation time of the one or more backups and a most recently updated version of the SLA retention policy of the one or more backups. In some aspects, the indication of the one or more updates made to the SLA retention policy may be applicable to the one or more data objects or to a subset of data objects of the one or more data objects. In some aspects, the indication of the one or more updates may be based on uploading an updated file version that includes the indication of the one or more updates made to the SLA retention policy to the archival location. In some such aspects, the updated file version may include a most recently uploaded file version relative to previous file versions from updates made to the SLA retention policy.

At 420, the data management system may perform an on-demand job to propagate the one or more updates made to the SLA retention policy to the one or more backups of the one or more data objects stored in the archival location. For example, performing the on-demand job may include updating a history of updates made to the SLA retention policy of the one or more backups of the one or more data objects already stored in the archival location.

In some examples, performing the on-demand job may include adding an entry corresponding to the one or more updates made to the SLA retention policy to a queue. For example, the queue may include one or more retention policy changes that are pending propagation to the one or more backups of the one or more data objects stored in the archival location. The data management system may then perform the on-demand job to propagate the one or more updates made to the SLA retention policy to the one or more backups of the one or more data objects in accordance with an ordering of the queue (e.g., a creation time-based ordering, where a lowest priority entry of the queue has a most recent creation time). After propagating the one or more updates made to the SLA retention policy to the one or more backups, the data management system may mark the entry in the queue as complete. In some implementations, the queue includes a propagation queue table that stores entries corresponding to the one or more retention policy changes that are pending propagation to the one or more backups of the one or more data objects stored in the archival location. In some implementations, the data management system may initiate a background job to monitor for pending entries in the queue such that a pending entry in the queue triggers execution of the on-demand job.

In some examples, performing the on-demand job may include adding an entry corresponding to the one or more updates made to the SLA retention policy to a queue, where the queue includes one or more retention policy changes that are pending propagation to the one or more backups of the one or more data objects stored in the archival location. In some such examples, the data management system may delay propagation of the one or more updates made to the SLA retention policy based on the archival location being inaccessible (e.g., at least temporarily inaccessible), and may propagate the one or more updates after the archival location becoming accessible.

In some examples, performing the on-demand job may include adding an entry corresponding to the one or more updates made to the SLA retention policy to a queue, where the queue includes one or more retention policy changes that are pending propagation to the one or more backups of the one or more data objects stored in a set of archival locations (that include both accessible and inaccessible archival locations). In some such examples, the data management system may propagate the one or more updates made to the SLA retention policy to the one or more backups that are stored in an accessible location of the set of archival locations, and may maintain the entry as a pending request until the inaccessible archival locations become accessible. In some examples, the data management system may initiate a job instance for the on-demand job whenever at least one previously inaccessible archival location becomes accessible.

In some implementations, the data management system may generate updated metadata that corresponds to the one or more updates made to the SLA retention policy, and may upload an updated version of the metadata file (which includes the updated metadata) to the archival location. In some examples, the updated metadata included in the updated version of the metadata file indicates one or more updates made to the SLA retention policy for a specific backup of a specific data object.

In some implementations, the one or more updates made to the SLA retention policy are for respective backups of a specific data object, and the data management system may generate updated metadata that corresponds to the one or more updates made to the SLA retention policy for the respective backups of the specific data object. The data management system may then upload updated metadata files for the respective backups of the specific data object to the archival location. In some examples, the updated metadata files may include at least the updated metadata that indicates the one or more updates made to the SLA retention policy for the specific data object and the respective backups of the specific data object.

In some implementations, the data management system may upload a new metadata file including the one or more updates to the SLA retention policy to the archival location. In some examples, the new metadata file may include a new version of one or more previously uploaded metadata files, where the new version has a higher priority than the one or more previously uploaded metadata files. The data management system may then propagate the one or more updates made to the SLA retention policy to the one or more backups of the one or more data objects stored in the archival location using the new metadata file.

In some implementations, the data management system may propagate the one or more updates made to the SLA retention policy to the one or more backups of the one or more data objects stored in the archival location concurrently with updating the SLA retention policy in a local metadata store external to the archival location. In some examples, the data management system may initiate the on-demand job based on a change in operation from a previous software release to an updated software release.

At 425, the data management system may establish a secondary data system to access the one or more backups of the one or more data objects stored in the archival location. The data management system may then promote the secondary data system from having read-only permissions to having owner permissions. In some examples, the data management system may extend a retention period associated with the SLA retention policy in the secondary data system based on promotion of the secondary data system from the read permission to the owner permission.

At 430, the data management system may manage (e.g., update, restore) the one or more data objects in the secondary data system in accordance with the one or more updates to the SLA retention policy.

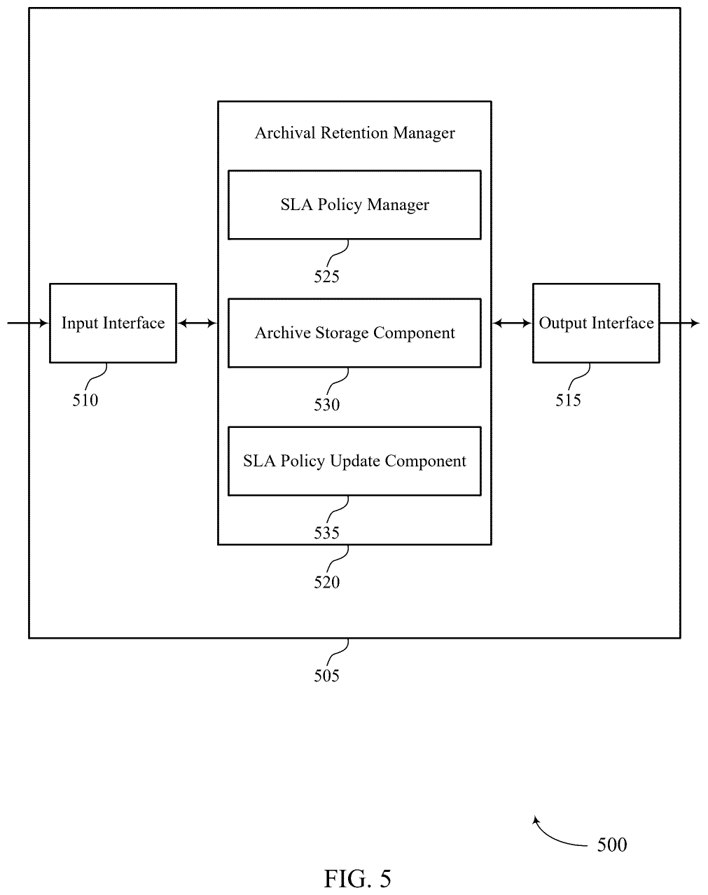

FIG. 5 shows a block diagram 500 of a system 505 that supports techniques for propagating retention policy changes for recovery from an archive in accordance with aspects of the present disclosure. In some examples, the system 505 may be an example of aspects of one or more components described with reference to FIG. 1, such as a DMS 110. The system 505 may include an input interface 510, an output interface 515, and an archival retention manager 520. The system 505 may also include one or more processors. Each of these components may be in communication with one another (e.g., via one or more buses, communications links, communications interfaces, or any combination thereof).

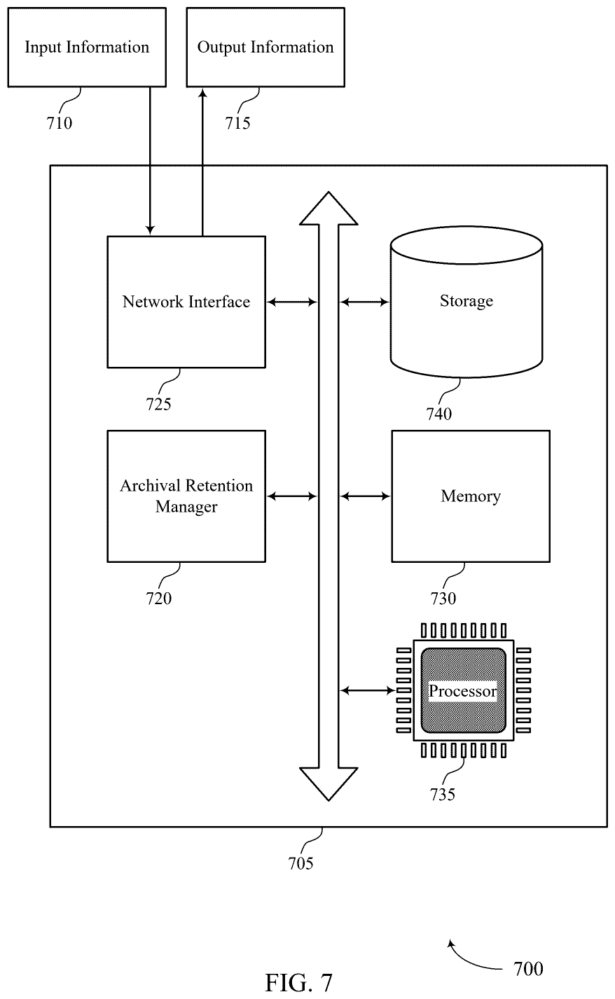

The input interface 510 may manage input signaling for the system 505. For example, the input interface 510 may receive input signaling (e.g., messages, packets, data, instructions, commands, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the archival retention manager 520 to support techniques for propagating retention policy changes for recovery from an archive. In some cases, the input interface 510 may be a component of a network interface 725 as described with reference to FIG. 7.

The output interface 515 may manage output signaling for the system 505. For example, the output interface 515 may receive signaling from other components of the system 505, such as the archival retention manager 520, and may transmit such output signaling corresponding to (e.g., representative of or otherwise based on) such signaling to other systems or devices. In some cases, the output interface 515 may be a component of a network interface 725 as described with reference to FIG. 7.

For example, the archival retention manager 520 may include an SLA policy manager 525, an archive storage component 530, an SLA policy update component 535, or any combination thereof. In some examples, the archival retention manager 520, or various components thereof, may be configured to perform various operations (e.g., receiving, monitoring, transmitting) using or otherwise in cooperation with the input interface 510, the output interface 515, or both. For example, the archival retention manager 520 may receive information from the input interface 510, send information to the output interface 515, or be integrated in combination with the input interface 510, the output interface 515, or both to receive information, transmit information, or perform various other operations as described herein.

The SLA policy manager 525 may be configured as or otherwise support a means for establishing a first data system in accordance with a SLA retention policy, where the SLA retention policy is indicative of a first duration that one or more backups of one or more data objects are retained by the first data system. The archive storage component 530 may be configured as or otherwise support a means for storing the one or more backups of the one or more data objects in an archival location in accordance with the SLA retention policy. The SLA policy update component 535 may be configured as or otherwise support a means for obtaining, from a user, an indication of one or more updates made to the SLA retention policy. The SLA policy update component 535 may be configured as or otherwise support a means for performing an on-demand job to propagate the one or more updates made to the SLA retention policy to the one or more backups of the one or more data objects stored in the archival location. The archive storage component 530 may be configured as or otherwise support a means for establishing a secondary data system to access the one or more backups of the one or more data objects stored in the archival location. The archive storage component 530 may be configured as or otherwise support a means for promoting the secondary data system from a read permission to an owner permission. The SLA policy manager 525 may be configured as or otherwise support a means for managing the one or more data objects in the secondary data system in accordance with the one or more updates to the SLA retention policy.

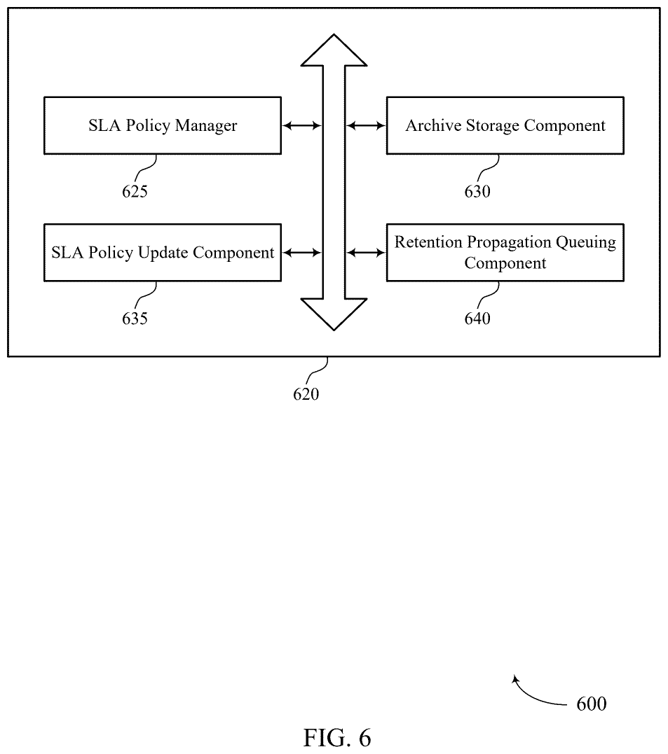

FIG. 6 shows a block diagram 600 of an archival retention manager 620 that supports techniques for propagating retention policy changes for recovery from an archive in accordance with aspects of the present disclosure. The archival retention manager 620 may be an example of aspects of an archival retention manager or an archival retention manager 520, or both, as described herein. The archival retention manager 620, or various components thereof, may be an example of means for performing various aspects of techniques for propagating retention policy changes for recovery from an archive as described herein. For example, the archival retention manager 620 may include an SLA policy manager 625, an archive storage component 630, an SLA policy update component 635, a retention propagation queuing component 640, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The SLA policy manager 625 may be configured as or otherwise support a means for establishing a first data system in accordance with a service level agreement (SLA) retention policy, where the SLA retention policy is indicative of a first duration that one or more backups of one or more data objects are retained by the first data system. The archive storage component 630 may be configured as or otherwise support a means for storing the one or more backups of the one or more data objects in an archival location in accordance with the SLA retention policy. The SLA policy update component 635 may be configured as or otherwise support a means for obtaining, from a user, an indication of one or more updates made to the SLA retention policy. In some examples, the SLA policy update component 635 may be configured as or otherwise support a means for performing an on-demand job to propagate the one or more updates made to the SLA retention policy to the one or more backups of the one or more data objects stored in the archival location. In some examples, the archive storage component 630 may be configured as or otherwise support a means for establishing a secondary data system to access the one or more backups of the one or more data objects stored in the archival location. In some examples, the archive storage component 630 may be configured as or otherwise support a means for promoting the secondary data system from a read permission to an owner permission. In some examples, the SLA policy manager 625 may be configured as or otherwise support a means for managing the one or more data objects in the secondary data system in accordance with the one or more updates to the SLA retention policy.

In some examples, the SLA policy update component 635 may be configured as or otherwise support a means for tracking retention information associated with the SLA retention policy over a time duration, the retention information including at least the SLA retention policy corresponding to a creation time of the one or more backups and a most recently updated version of the SLA retention policy of the one or more backups.

In some examples, to support performing the on-demand job, the SLA policy update component 635 may be configured as or otherwise support a means for performing the on-demand job to update a history of updates made to the SLA retention policy of the one or more backups of the one or more data objects already stored in the archival location.

In some examples, to support performing the on-demand job, the retention propagation queuing component 640 may be configured as or otherwise support a means for adding an entry corresponding to the one or more updates made to the SLA retention policy to a queue, where the queue includes one or more retention policy changes that are pending propagation to the one or more backups of the one or more data objects stored in the archival location. In some examples, to support performing the on-demand job, the retention propagation queuing component 640 may be configured as or otherwise support a means for performing the on-demand job to propagate the one or more updates made to the SLA retention policy to the one or more backups of the one or more data objects in accordance with an ordering of the queue.

In some examples, the queue includes a propagation queue table that stores entries corresponding to the one or more retention policy changes that are pending propagation to the one or more backups of the one or more data objects stored in the archival location. In some examples, the ordering of the queue includes a creation time-based ordering. In some examples, a lowest priority entry of the queue has a most recent creation time.

In some examples, the retention propagation queuing component 640 may be configured as or otherwise support a means for marking the entry as complete subsequent to propagating the one or more updates made to the SLA retention policy. In some examples, the retention propagation queuing component 640 may be configured as or otherwise support a means for initiating a background job to monitor for pending entries in the queue, where a pending entry triggers execution of the on-demand job.

In some examples, the SLA policy update component 635 may be configured as or otherwise support a means for generating updated metadata corresponding to the one or more updates made to the SLA retention policy. In some examples, the SLA policy update component 635 may be configured as or otherwise support a means for uploading an updated version of a metadata file including at least the updated metadata to the archival location, where the updated metadata indicates the one or more updates made to the SLA retention policy for a specific backup of a specific data object.

In some examples, the one or more updates to the SLA retention policy are for respective backups of a specific data object, and the SLA policy update component 635 may be configured as or otherwise support a means for generating updated metadata corresponding to the one or more updates made to the SLA retention policy for the respective backups of the specific data object. In some examples, the one or more updates to the SLA retention policy are for respective backups of a specific data object, and the SLA policy update component 635 may be configured as or otherwise support a means for uploading, to the archival location, updated metadata files for the respective backups of the specific data object, where the updated metadata files include at least the updated metadata that indicates the one or more updates made to the SLA retention policy for the specific data object and the respective backups of the specific data object.

In some examples, the SLA policy update component 635 may be configured as or otherwise support a means for uploading, to the archival location, a new metadata file including the one or more updates to the SLA retention policy, where the new metadata file includes a new version of one or more previously uploaded metadata files, the new version having a higher priority than the one or more previously uploaded metadata files. In some examples, the SLA policy update component 635 may be configured as or otherwise support a means for propagating the one or more updates made to the SLA retention policy to the one or more backups of the one or more data objects stored in the archival location in accordance with the new metadata file. In some examples, the indication of the one or more updates made to the SLA retention policy are applicable to the one or more data objects or to a subset of data objects of the one or more data objects.

In some examples, to support performing the on-demand job, the retention propagation queuing component 640 may be configured as or otherwise support a means for adding an entry corresponding to the one or more updates made to the SLA retention policy to a queue, where the queue includes one or more retention policy changes that are pending propagation to the one or more backups of the one or more data objects stored in the archival location. In some examples, to support performing the on-demand job, the retention propagation queuing component 640 may be configured as or otherwise support a means for delaying propagation of the one or more updates made to the SLA retention policy based on the archival location being inaccessible. In some examples, to support performing the on-demand job, the retention propagation queuing component 640 may be configured as or otherwise support a means for propagating the one or more updates made to the SLA retention policy to the one or more backups of the one or more data objects stored in the archival location subsequent to the archival location becoming accessible.

In some examples, to support performing the on-demand job, the retention propagation queuing component 640 may be configured as or otherwise support a means for adding an entry corresponding to the one or more updates made to the SLA retention policy to a queue, where the queue includes one or more retention policy changes that are pending propagation to the one or more backups of the one or more data objects stored in a set of multiple archival locations including the archival location. In some examples, to support performing the on-demand job, the retention propagation queuing component 640 may be configured as or otherwise support a means for propagating the one or more updates made to the SLA retention policy to the one or more backups of the one or more data objects stored in an accessible archival location of the set of multiple archival locations, where the set of multiple archival locations include accessible archival locations and inaccessible archival locations. In some examples, to support performing the on-demand job, the retention propagation queuing component 640 may be configured as or otherwise support a means for maintaining the entry as a pending request until the inaccessible archival locations become accessible.

In some examples, the retention propagation queuing component 640 may be configured as or otherwise support a means for initiating a job instance for the on-demand job based on at least one inaccessible archival location becoming accessible.

In some examples, the SLA policy update component 635 may be configured as or otherwise support a means for uploading an updated file version that includes the indication of the one or more updates made to the SLA retention policy to the archival location. In some examples, the updated file version includes a most recently uploaded file version of a set of multiple file versions, the set of multiple file versions corresponding to respective previous updates made to the SLA retention policy. In some examples, the SLA policy update component 635 may be configured as or otherwise support a means for propagating the one or more updates made to the SLA retention policy to the one or more backups of the one or more data objects stored in the archival location concurrently with updating the SLA retention policy in a local metadata store external to the archival location.

In some examples, the SLA policy update component 635 may be configured as or otherwise support a means for initiating a job instance for the on-demand job based on obtaining the indication of the one or more updates made to the SLA retention policy. In some examples, the SLA policy update component 635 may be configured as or otherwise support a means for initiating a job instance for the on-demand job based on a change in operation from a previous software release to an updated software release.

In some examples, the SLA policy update component 635 may be configured as or otherwise support a means for extending a retention period associated with the SLA retention policy of the one or more data objects in the secondary data system based on promotion of the secondary data system from the read permission to the owner permission. In some examples, the one or more data objects include one or more individual backups, one or more data snapshots (e.g., data backups) or snappables (e.g., data objects), one or more groups of snapshots, one or more groups of backups, or any combination thereof.

FIG. 7 shows a block diagram 700 of a system 705 that supports techniques for propagating retention policy changes for recovery from an archive in accordance with aspects of the present disclosure. The system 705 may be an example of or include components of a system 505 as described herein. The system 705 may include components for data management, including components such as an archival retention manager 720, an input information 710, an output information 715, a network interface 725, at least one memory 730, at least one processor 735, and a storage 740. These components may be in electronic communication or otherwise coupled with each other (e.g., operatively, communicatively, functionally, electronically, electrically; via one or more buses, communications links, communications interfaces, or any combination thereof). Additionally, the components of the system 705 may include corresponding physical components or may be implemented as corresponding virtual components (e.g., components of one or more virtual machines). In some examples, the system 705 may be an example of aspects of one or more components described with reference to FIG. 1, such as a DMS 110.

The network interface 725 may enable the system 705 to exchange information (e.g., input information 710, output information 715, or both) with other systems or devices (not shown). For example, the network interface 725 may enable the system 705 to connect to a network (e.g., a network 120 as described herein). The network interface 725 may include one or more wireless network interfaces, one or more wired network interfaces, or any combination thereof. In some examples, the network interface 725 may be an example of may be an example of aspects of one or more components described with reference to FIG. 1, such as one or more network interfaces 165.

Memory 730 may include RAM, ROM, or both. The memory 730 may store computer-readable, computer-executable software including instructions that, when executed, cause the processor 735 to perform various functions described herein. In some cases, the memory 730 may contain, among other things, a basic input/output system (BIOS), which may control basic hardware or software operation such as the interaction with peripheral components or devices. In some cases, the memory 730 may be an example of aspects of one or more components described with reference to FIG. 1, such as one or more memories 175.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in a memory 730 to perform various functions (e.g., functions or tasks supporting techniques for propagating retention policy changes for recovery from an archive). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. In some cases, the processor 735 may be an example of aspects of one or more components described with reference to FIG. 1, such as one or more processors 170.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1, such as one or more network disks 180.

For example, the archival retention manager 720 may be configured as or otherwise support a means for establishing a first data system in accordance with a SLA retention policy, where the SLA retention policy is indicative of a first duration that one or more backups of one or more data objects are retained by the first data system. The archival retention manager 720 may be configured as or otherwise support a means for storing the one or more backups of the one or more data objects in an archival location in accordance with the SLA retention policy. The archival retention manager 720 may be configured as or otherwise support a means for obtaining, from a user, an indication of one or more updates made to the SLA retention policy. The archival retention manager 720 may be configured as or otherwise support a means for performing an on-demand job to propagate the one or more updates made to the SLA retention policy to the one or more backups of the one or more data objects stored in the archival location. The archival retention manager 720 may be configured as or otherwise support a means for establishing a secondary data system to access the one or more backups of the one or more data objects stored in the archival location. The archival retention manager 720 may be configured as or otherwise support a means for promoting the secondary data system from a read permission to an owner permission. The archival retention manager 720 may be configured as or otherwise support a means for managing the one or more data objects in the secondary data system in accordance with the one or more updates to the SLA retention policy.

By including or configuring the archival retention manager 720 in accordance with examples as described herein, the system 705 may support techniques for techniques for propagating retention policy changes for recovery from an archive, which may provide one or more benefits such as, for example, improved reliability, improved user experience, more efficient utilization of computing resources, network resources or both, improved scalability, or improved security, improved techniques for ongoing tracking of updating of retention policy information, improved accuracy and reliability for data recovery, improved support for archival storage, among other possibilities.

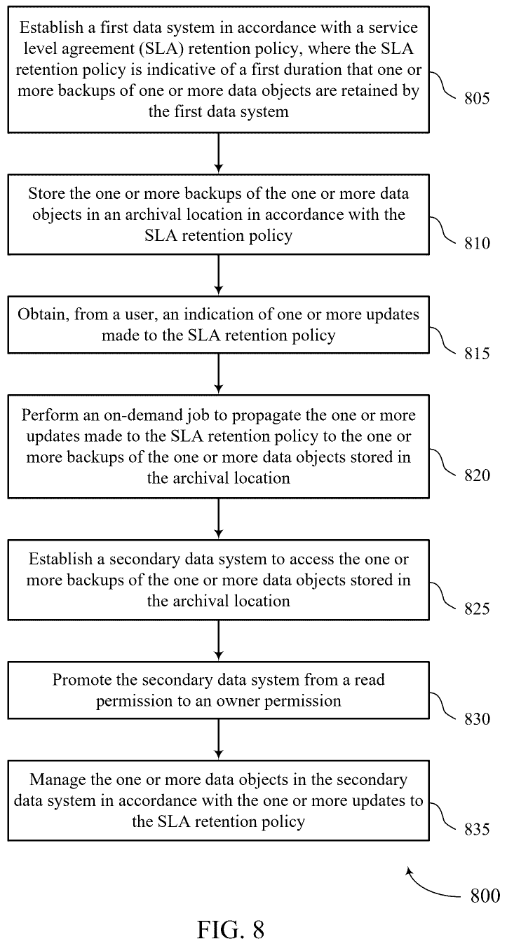

FIG. 8 shows a flowchart illustrating a method 800 that supports techniques for propagating retention policy changes for recovery from an archive in accordance with aspects of the present disclosure. The operations of the method 800 may be implemented by a DMS or its components as described herein. For example, the operations of the method 800 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 805, the method may include establishing a first data system in accordance with a SLA retention policy, where the SLA retention policy is indicative of a first duration that one or more backups of one or more data objects are retained by the first data system. The operations of 805 may be performed in accordance with examples as disclosed herein. In some examples, aspects of the operations of 805 may be performed by an SLA policy manager 625 as described with reference to FIG. 6.

At 810, the method may include storing the one or more backups of the one or more data objects in an archival location in accordance with the SLA retention policy. The operations of 810 may be performed in accordance with examples as disclosed herein. In some examples, aspects of the operations of 810 may be performed by an archive storage component 630 as described with reference to FIG. 6.

At 815, the method may include obtaining, from a user, an indication of one or more updates made to the SLA retention policy. The operations of 815 may be performed in accordance with examples as disclosed herein. In some examples, aspects of the operations of 815 may be performed by an SLA policy update component 635 as described with reference to FIG. 6.

At 820, the method may include performing an on-demand job to propagate the one or more updates made to the SLA retention policy to the one or more backups of the one or more data objects stored in the archival location. The operations of 820 may be performed in accordance with examples as disclosed herein. In some examples, aspects of the operations of 820 may be performed by an SLA policy update component 635 as described with reference to FIG. 6. At 825, the method may include establishing a secondary data system to access the one or more backups of the one or more data objects stored in the archival location. The operations of 825 may be performed in accordance with examples as disclosed herein. In some examples, aspects of the operations of 825 may be performed by an archive storage component 630 as described with reference to FIG. 6.

At 830, the method may include promoting the secondary data system from a read permission to an owner permission. The operations of 830 may be performed in accordance with examples as disclosed herein. In some examples, aspects of the operations of 830 may be performed by an archive storage component 630 as described with reference to FIG. 6.

At 835, the method may include managing the one or more data objects in the secondary data system in accordance with the one or more updates to the SLA retention policy. The operations of 835 may be performed in accordance with examples as disclosed herein. In some examples, aspects of the operations of 835 may be performed by an SLA policy manager 625 as described with reference to FIG. 6.

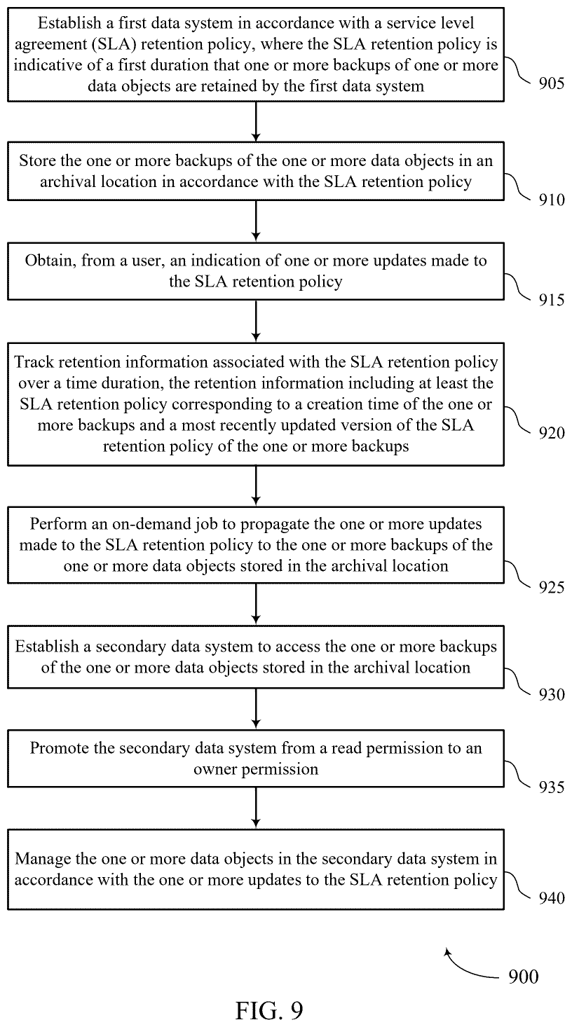

FIG. 9 shows a flowchart illustrating a method 900 that supports techniques for propagating retention policy changes for recovery from an archive in accordance with aspects of the present disclosure. The operations of the method 900 may be implemented by a DMS or its components as described herein. For example, the operations of the method 900 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 905, the method may include establishing a first data system in accordance with a SLA retention policy, where the SLA retention policy is indicative of a first duration that one or more backups of one or more data objects are retained by the first data system. The operations of 905 may be performed in accordance with examples as disclosed herein. In some examples, aspects of the operations of 905 may be performed by an SLA policy manager 625 as described with reference to FIG. 6.

At 910, the method may include storing the one or more backups of the one or more data objects in an archival location in accordance with the SLA retention policy. The operations of 910 may be performed in accordance with examples as disclosed herein. In some examples, aspects of the operations of 910 may be performed by an archive storage component 630 as described with reference to FIG. 6.

At 915, the method may include obtaining, from a user, an indication of one or more updates made to the SLA retention policy. The operations of 915 may be performed in accordance with examples as disclosed herein. In some examples, aspects of the operations of 915 may be performed by an SLA policy update component 635 as described with reference to FIG. 6.

At 920, the method may include tracking retention information associated with the SLA retention policy over a time duration, the retention information including at least the SLA retention policy corresponding to a creation time of the one or more backups and a most recently updated version of the SLA retention policy of the one or more backups. The operations of 920 may be performed in accordance with examples as disclosed herein. In some examples, aspects of the operations of 920 may be performed by an SLA policy update component 635 as described with reference to FIG. 6.

At 925, the method may include performing an on-demand job to propagate the one or more updates made to the SLA retention policy to the one or more backups of the one or more data objects stored in the archival location. The operations of 925 may be performed in accordance with examples as disclosed herein. In some examples, aspects of the operations of 925 may be performed by an SLA policy update component 635 as described with reference to FIG. 6.

At 930, the method may include establishing a secondary data system to access the one or more backups of the one or more data objects stored in the archival location. The operations of 930 may be performed in accordance with examples as disclosed herein. In some examples, aspects of the operations of 930 may be performed by an archive storage component 630 as described with reference to FIG. 6.

At 935, the method may include promoting the secondary data system from a read permission to an owner permission. The operations of 935 may be performed in accordance with examples as disclosed herein. In some examples, aspects of the operations of 935 may be performed by an archive storage component 630 as described with reference to FIG. 6.

At 940, the method may include managing the one or more data objects in the secondary data system in accordance with the one or more updates to the SLA retention policy. The operations of 940 may be performed in accordance with examples as disclosed herein. In some examples, aspects of the operations of 940 may be performed by an SLA policy manager 625 as described with reference to FIG. 6.

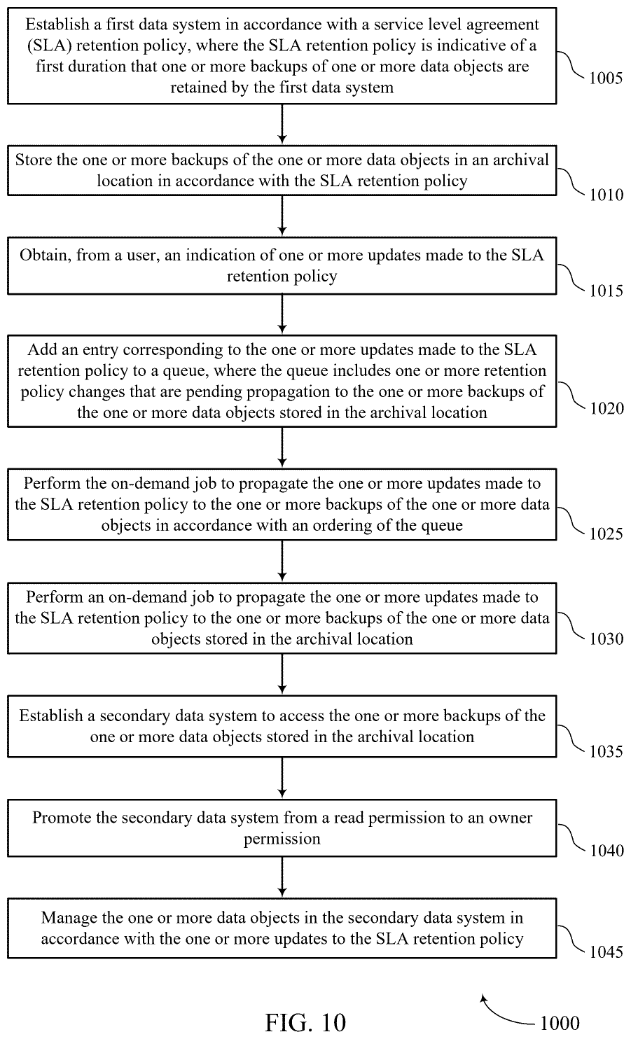

FIG. 10 shows a flowchart illustrating a method 1000 that supports techniques for propagating retention policy changes for recovery from an archive in accordance with aspects of the present disclosure. The operations of the method 1000 may be implemented by a DMS or its components as described herein. For example, the operations of the method 1000 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 1005, the method may include establishing a first data system in accordance with a SLA retention policy, where the SLA retention policy is indicative of a first duration that one or more backups of one or more data objects are retained by the first data system. The operations of 1005 may be performed in accordance with examples as disclosed herein. In some examples, aspects of the operations of 1005 may be performed by an SLA policy manager 625 as described with reference to FIG. 6.

At 1010, the method may include storing the one or more backups of the one or more data objects in an archival location in accordance with the SLA retention policy. The operations of 1010 may be performed in accordance with examples as disclosed herein. In some examples, aspects of the operations of 1010 may be performed by an archive storage component 630 as described with reference to FIG. 6.

At 1015, the method may include obtaining, from a user, an indication of one or more updates made to the SLA retention policy. The operations of 1015 may be performed in accordance with examples as disclosed herein. In some examples, aspects of the operations of 1015 may be performed by an SLA policy update component 635 as described with reference to FIG. 6.

At 1020, the method may include adding an entry corresponding to the one or more updates made to the SLA retention policy to a queue, where the queue includes one or more retention policy changes that are pending propagation to the one or more backups of the one or more data objects stored in the archival location. The operations of 1020 may be performed in accordance with examples as disclosed herein. In some examples, aspects of the operations of 1020 may be performed by a retention propagation queuing component 640 as described with reference to FIG. 6.

At 1025, the method may include performing the on-demand job to propagate the one or more updates made to the SLA retention policy to the one or more backups of the one or more data objects in accordance with an ordering of the queue. The operations of 1025 may be performed in accordance with examples as disclosed herein. In some examples, aspects of the operations of 1025 may be performed by a retention propagation queuing component 640 as described with reference to FIG. 6.

At 1030, the method may include performing an on-demand job to propagate the one or more updates made to the SLA retention policy to the one or more backups of the one or more data objects stored in the archival location. The operations of 1030 may be performed in accordance with examples as disclosed herein. In some examples, aspects of the operations of 1030 may be performed by an SLA policy update component 635 as described with reference to FIG. 6.

At 1035, the method may include establishing a secondary data system to access the one or more backups of the one or more data objects stored in the archival location. The operations of 1035 may be performed in accordance with examples as disclosed herein. In some examples, aspects of the operations of 1035 may be performed by an archive storage component 630 as described with reference to FIG. 6.

At 1040, the method may include promoting the secondary data system from a read permission to an owner permission. The operations of 1040 may be performed in accordance with examples as disclosed herein. In some examples, aspects of the operations of 1040 may be performed by an archive storage component 630 as described with reference to FIG. 6.

At 1045, the method may include managing the one or more data objects in the secondary data system in accordance with the one or more updates to the SLA retention policy. The operations of 1045 may be performed in accordance with examples as disclosed herein. In some examples, aspects of the operations of 1045 may be performed by an SLA policy manager 625 as described with reference to FIG. 6.

A method by an apparatus is described. The method may include establishing a first data system in accordance with a SLA retention policy, where the SLA retention policy is indicative of a first duration that one or more backups of one or more data objects are retained by the first data system, storing the one or more backups of the one or more data objects in an archival location in accordance with the SLA retention policy, obtaining, from a user, an indication of one or more updates made to the SLA retention policy, performing an on-demand job to propagate the one or more updates made to the SLA retention policy to the one or more backups of the one or more data objects stored in the archival location, establishing a secondary data system to access the one or more backups of the one or more data objects stored in the archival location, promoting the secondary data system from a read permission to an owner permission, and managing the one or more data objects in the secondary data system in accordance with the one or more updates to the SLA retention policy.

An apparatus is described. The apparatus may include one or more memories storing processor executable code, and one or more processors coupled with the one or more memories. The one or more processors may individually or collectively be operable to execute the code to cause the apparatus to establish a first data system in accordance with a SLA retention policy, where the SLA retention policy is indicative of a first duration that one or more backups of one or more data objects are retained by the first data system, store the one or more backups of the one or more data objects in an archival location in accordance with the SLA retention policy, obtain, from a user, an indication of one or more updates made to the SLA retention policy, perform an on-demand job to propagate the one or more updates made to the SLA retention policy to the one or more backups of the one or more data objects stored in the archival location, establish a secondary data system to access the one or more backups of the one or more data objects stored in the archival location, promote the secondary data system from a read permission to an owner permission, and manage the one or more data objects in the secondary data system in accordance with the one or more updates to the SLA retention policy.

Another apparatus is described. The apparatus may include means for establishing a first data system in accordance with a SLA retention policy, where the SLA retention policy is indicative of a first duration that one or more backups of one or more data objects are retained by the first data system, means for storing the one or more backups of the one or more data objects in an archival location in accordance with the SLA retention policy, means for obtaining, from a user, an indication of one or more updates made to the SLA retention policy, means for performing an on-demand job to propagate the one or more updates made to the SLA retention policy to the one or more backups of the one or more data objects stored in the archival location, means for establishing a secondary data system to access the one or more backups of the one or more data objects stored in the archival location, means for promoting the secondary data system from a read permission to an owner permission, and means for managing the one or more data objects in the secondary data system in accordance with the one or more updates to the SLA retention policy.

A non-transitory computer-readable medium storing code is described. The code may include instructions executable by one or more processors to establish a first data system in accordance with a SLA retention policy, where the SLA retention policy is indicative of a first duration that one or more backups of one or more data objects are retained by the first data system, store the one or more backups of the one or more data objects in an archival location in accordance with the SLA retention policy, obtain, from a user, an indication of one or more updates made to the SLA retention policy, perform an on-demand job to propagate the one or more updates made to the SLA retention policy to the one or more backups of the one or more data objects stored in the archival location, establish a secondary data system to access the one or more backups of the one or more data objects stored in the archival location, promote the secondary data system from a read permission to an owner permission, and manage the one or more data objects in the secondary data system in accordance with the one or more updates to the SLA retention policy.

Some examples of the method, apparatus, and non-transitory computer-readable medium described herein may further include operations, features, means, or instructions for tracking retention information associated with the SLA retention policy over a time duration, the retention information including at least the SLA retention policy corresponding to a creation time of the one or more backups and a most recently updated version of the SLA retention policy of the one or more backups.

In some examples of the method, apparatus, and non-transitory computer-readable medium described herein, performing the on-demand job may include operations, features, means, or instructions for performing the on-demand job to update a history of updates made to the SLA retention policy of the one or more backups of the one or more data objects already stored in the archival location.

In some examples of the method, apparatus, and non-transitory computer-readable medium described herein, performing the on-demand job may include operations, features, means, or instructions for adding an entry corresponding to the one or more updates made to the SLA retention policy to a queue, where the queue includes one or more retention policy changes that may be pending propagation to the one or more backups of the one or more data objects stored in the archival location and performing the on-demand job to propagate the one or more updates made to the SLA retention policy to the one or more backups of the one or more data objects in accordance with an ordering of the queue.

In some examples of the method, apparatus, and non-transitory computer-readable medium described herein, the queue includes a propagation queue table that stores entries corresponding to the one or more retention policy changes that may be pending propagation to the one or more backups of the one or more data objects stored in the archival location.

In some examples of the method, apparatus, and non-transitory computer-readable medium described herein, the ordering of the queue includes a creation time-based ordering and a lowest priority entry of the queue may have a most recent creation time.

Some examples of the method, apparatus, and non-transitory computer-readable medium described herein may further include operations, features, means, or instructions for marking the entry as complete subsequent to propagating the one or more updates made to the SLA retention policy.

Some examples of the method, apparatus, and non-transitory computer-readable medium described herein may further include operations, features, means, or instructions for initiating a background job to monitor for pending entries in the queue, where a pending entry triggers execution of the on-demand job.

Some examples of the method, apparatus, and non-transitory computer-readable medium described herein may further include operations, features, means, or instructions for generating updated metadata corresponding to the one or more updates made to the SLA retention policy and uploading an updated version of a metadata file including at least the updated metadata to the archival location, where the updated metadata indicates the one or more updates made to the SLA retention policy for a specific backup of a specific data object.

In some examples of the method, apparatus, and non-transitory computer-readable medium described herein, the one or more updates to the SLA retention policy may be for respective backups of a specific data object and the method, apparatuses, and non-transitory computer-readable medium may include further operations, features, means, or instructions for generating updated metadata corresponding to the one or more updates made to the SLA retention policy for the respective backups of the specific data object and uploading, to the archival location, updated metadata files for the respective backups of the specific data object, where the updated metadata files include at least the updated metadata that indicates the one or more updates made to the SLA retention policy for the specific data object and the respective backups of the specific data object.

Some examples of the method, apparatus, and non-transitory computer-readable medium described herein may further include operations, features, means, or instructions for uploading, to the archival location, a new metadata file including the one or more updates to the SLA retention policy, where the new metadata file includes a new version of one or more previously uploaded metadata files, the new version having a higher priority than the one or more previously uploaded metadata files and propagating the one or more updates made to the SLA retention policy to the one or more backups of the one or more data objects stored in the archival location in accordance with the new metadata file.

In some examples of the method, apparatus, and non-transitory computer-readable medium described herein, the indication of the one or more updates made to the SLA retention policy may be applicable to the one or more data objects or to a subset of data objects of the one or more data objects.

In some examples of the method, apparatus, and non-transitory computer-readable medium described herein, performing the on-demand job may include operations, features, means, or instructions for adding an entry corresponding to the one or more updates made to the SLA retention policy to a queue, where the queue includes one or more retention policy changes that may be pending propagation to the one or more backups of the one or more data objects stored in the archival location, delaying propagation of the one or more updates made to the SLA retention policy based on the archival location being inaccessible, and propagating the one or more updates made to the SLA retention policy to the one or more backups of the one or more data objects stored in the archival location subsequent to the archival location becoming accessible.

In some examples of the method, apparatus, and non-transitory computer-readable medium described herein, performing the on-demand job may include operations, features, means, or instructions for adding an entry corresponding to the one or more updates made to the SLA retention policy to a queue, where the queue includes one or more retention policy changes that may be pending propagation to the one or more backups of the one or more data objects stored in a set of multiple archival locations including the archival location, propagating the one or more updates made to the SLA retention policy to the one or more backups of the one or more data objects stored in an accessible archival location of the set of multiple archival locations, where the set of multiple archival locations include accessible archival locations and inaccessible archival locations, and maintaining the entry as a pending request until the inaccessible archival locations become accessible.

Some examples of the method, apparatus, and non-transitory computer-readable medium described herein may further include operations, features, means, or instructions for initiating a job instance for the on-demand job based on at least one inaccessible archival location becoming accessible.

Some examples of the method, apparatus, and non-transitory computer-readable medium described herein may further include operations, features, means, or instructions for uploading an updated file version that includes the indication of the one or more updates made to the SLA retention policy to the archival location.

In some examples of the method, apparatus, and non-transitory computer-readable medium described herein, the updated file version includes a most recently uploaded file version of a set of multiple file versions, the set of multiple file versions corresponding to respective previous updates made to the SLA retention policy.

Some examples of the method, apparatus, and non-transitory computer-readable medium described herein may further include operations, features, means, or instructions for propagating the one or more updates made to the SLA retention policy to the one or more backups of the one or more data objects stored in the archival location concurrently with updating the SLA retention policy in a local metadata store external to the archival location.

Some examples of the method, apparatus, and non-transitory computer-readable medium described herein may further include operations, features, means, or instructions for initiating a job instance for the on-demand job based on obtaining the indication of the one or more updates made to the SLA retention policy.

Some examples of the method, apparatus, and non-transitory computer-readable medium described herein may further include operations, features, means, or instructions for initiating a job instance for the on-demand job based on a change in operation from a previous software release to an updated software release.

Some examples of the method, apparatus, and non-transitory computer-readable medium described herein may further include operations, features, means, or instructions for extending a retention period associated with the SLA retention policy of the one or more data objects in the secondary data system based on promotion of the secondary data system from the read permission to the owner permission.

In some examples of the method, apparatus, and non-transitory computer-readable medium described herein, the one or more data objects include one or more individual backups, one or more data snapshots or snappables, one or more groups of snapshots, one or more groups of backups, or any combination thereof.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method, comprising:
establishing a first data system in accordance with a service level agreement (SLA) retention policy, wherein the SLA retention policy is indicative of a first duration that one or more backups of one or more data objects are retained by the first data system;
storing the one or more backups of the one or more data objects in an archival location in accordance with the SLA retention policy;
obtaining, from a user, an indication of one or more updates made to the SLA retention policy;
performing, in response to the obtaining the indication of the one or more updates made to the SLA retention policy, an on-demand job to propagate the one or more updates made to the SLA retention policy to the one or more backups of the one or more data objects stored in the archival location;
establishing a secondary data system to access the one or more backups of the one or more data objects stored in the archival location;
promoting the secondary data system from a read permission to an owner permission; and
restoring the one or more data objects in the secondary data system in accordance with the one or more updates to the SLA retention policy.

2. The method of claim 1, further comprising:
tracking retention information associated with the SLA retention policy over a time duration, the retention information including at least the SLA retention policy corresponding to a creation time of the one or more backups and a most recently updated version of the SLA retention policy of the one or more backups.

3. The method of claim 1, wherein performing the on-demand job comprises:
performing the on-demand job to update a history of updates made to the SLA retention policy of the one or more backups of the one or more data objects already stored in the archival location.

4. The method of claim 1, wherein performing the on-demand job comprises:
adding an entry corresponding to the one or more updates made to the SLA retention policy to a queue, wherein the queue includes one or more retention policy changes that are pending propagation to the one or more backups of the one or more data objects stored in the archival location; and
performing the on-demand job to propagate the one or more updates made to the SLA retention policy to the one or more backups of the one or more data objects in accordance with an ordering of the queue.

5. The method of claim 4, wherein the queue comprises a propagation queue table that stores entries corresponding to the one or more retention policy changes that are pending propagation to the one or more backups of the one or more data objects stored in the archival location.

6. The method of claim 4, wherein the ordering of the queue comprises a creation time-based ordering, and a lowest priority entry of the queue has a most recent creation time.

7. The method of claim 4, further comprising:
marking the entry as complete subsequent to propagating the one or more updates made to the SLA retention policy.

8. The method of claim 4, further comprising:
initiating a background job to monitor for pending entries in the queue, wherein a pending entry triggers execution of the on-demand job.

9. The method of claim 1, further comprising:
generating updated metadata corresponding to the one or more updates made to the SLA retention policy; and
uploading an updated version of a metadata file including at least the updated metadata to the archival location, wherein the updated metadata indicates the one or more updates made to the SLA retention policy for a specific backup of a specific data object.

10. The method of claim 1, wherein the one or more updates to the SLA retention policy are for respective backups of a specific data object, the method further comprising:
generating updated metadata corresponding to the one or more updates made to the SLA retention policy for the respective backups of the specific data object; and
uploading, to the archival location, updated metadata files for the respective backups of the specific data object, wherein the updated metadata files include at least the updated metadata that indicates the one or more updates made to the SLA retention policy for the specific data object and the respective backups of the specific data object.

11. The method of claim 1, further comprising:
uploading, to the archival location, a new metadata file including the one or more updates to the SLA retention policy, wherein the new metadata file comprises a new version of one or more previously uploaded metadata files, the new version having a higher priority than the one or more previously uploaded metadata files; and
propagating the one or more updates made to the SLA retention policy to the one or more backups of the one or more data objects stored in the archival location in accordance with the new metadata file.

12. The method of claim 1, wherein the indication of the one or more updates made to the SLA retention policy are applicable to the one or more data objects or to a subset of data objects of the one or more data objects.

13. The method of claim 1, wherein performing the on-demand job comprises:
adding an entry corresponding to the one or more updates made to the SLA retention policy to a queue, wherein the queue includes one or more retention policy changes that are pending propagation to the one or more backups of the one or more data objects stored in the archival location;
delaying propagation of the one or more updates made to the SLA retention policy based at least in part on the archival location being inaccessible; and
propagating the one or more updates made to the SLA retention policy to the one or more backups of the one or more data objects stored in the archival location subsequent to the archival location becoming accessible.

14. The method of claim 1, wherein performing the on-demand job comprises:
adding an entry corresponding to the one or more updates made to the SLA retention policy to a queue, wherein the queue includes one or more retention policy changes that are pending propagation to the one or more backups of the one or more data objects stored in a plurality of archival locations including the archival location;
propagating the one or more updates made to the SLA retention policy to the one or more backups of the one or more data objects stored in an accessible archival location of the plurality of archival locations, wherein the plurality of archival locations include accessible archival locations and inaccessible archival locations; and
maintaining the entry as a pending request until the inaccessible archival locations become accessible.

15. The method of claim 14, further comprising:
initiating a job instance for the on-demand job based at least in part on at least one inaccessible archival location becoming accessible.

16. The method of claim 1, further comprising:
uploading an updated file version that includes the indication of the one or more updates made to the SLA retention policy to the archival location.

17. The method of claim 16, wherein the updated file version comprises a most recently uploaded file version of a plurality of file versions, the plurality of file versions corresponding to respective previous updates made to the SLA retention policy.

18. The method of claim 1, further comprising:
propagating the one or more updates made to the SLA retention policy to the one or more backups of the one or more data objects stored in the archival location concurrently with updating the SLA retention policy in a local metadata store external to the archival location.

19. An apparatus, comprising:
one or more memories storing processor-executable code; and
one or more processors coupled with the one or more memories and individually or collectively operable to execute the code to cause the apparatus to:
establish a first data system in accordance with a service level agreement (SLA) retention policy, wherein the SLA retention policy is indicative of a first duration that one or more backups of one or more data objects are retained by the first data system;
store the one or more backups of the one or more data objects in an archival location in accordance with the SLA retention policy;
obtain, from a user, an indication of one or more updates made to the SLA retention policy;
perform, in response to obtaining the indication of the one or more updates made to the SLA retention policy, an on-demand job to propagate the one or more updates made to the SLA retention policy to the one or more backups of the one or more data objects stored in the archival location;
establish a secondary data system to access the one or more backups of the one or more data objects stored in the archival location;
promote the secondary data system from a read permission to an owner permission; and
restore the one or more data objects in the secondary data system in accordance with the one or more updates to the SLA retention policy.

20. A non-transitory computer-readable medium storing code, the code comprising instructions executable by one or more processors to:
establish a first data system in accordance with a service level agreement (SLA) retention policy, wherein the SLA retention policy is indicative of a first duration that one or more backups of one or more data objects are retained by the first data system;
store the one or more backups of the one or more data objects in an archival location in accordance with the SLA retention policy;
obtain, from a user, an indication of one or more updates made to the SLA retention policy;
perform, in response to obtaining the indication of the one or more updates made to the SLA retention policy, an on-demand job to propagate the one or more updates made to the SLA retention policy to the one or more backups of the one or more data objects stored in the archival location;
establish a secondary data system to access the one or more backups of the one or more data objects stored in the archival location;
promote the secondary data system from a read permission to an owner permission; and
restore the one or more data objects in the secondary data system in accordance with the one or more updates to the SLA retention policy.
